(19) United States
(12) Patent Application Publication
(10) Pub. No.: US 2005/0222911 A1
(43) Pub. Date: Oct. 6, 2005

(54) System and method for returning merchandise

(75) Inventors: William S. Kerker, Jenison, MI (US); Sakire F. Ozcan, Grand Rapids, MI (US); David M. Stump, Gowen, MI (US); Darrell W. Tanis, Hudsonville, MI (US)

Correspondence Address: BRINKS HOFER GILSON & LIONE, P.O. BOX 10395, CHICAGO, IL, 60610, US

(73) Assignee: Quixtar Investments, Inc.

(21) Appl. No.: 10/812,806

(22) Filed: Mar. 30, 2004

(51) Int. Cl. G06F 17/60

(52) U.S. Cl. 705/26

(57) ABSTRACT

A system and method for returning merchandise to a merchant over a computer network is disclosed. According to one embodiment, a merchant computer receives a merchandise identifier associated with the merchandise to be returned. The merchant computer creates a merchandise return form having the merchandise identifier of the merchandise to be returned, and transmits the merchandise return form over the computer network to the customer computer.

### TECHNICAL FIELD

The disclosed embodiments relate to systems and methods for providing a process by which customers may return unwanted merchandise to a seller.

### BRIEF DESCRIPTION OF THE DRAWINGS

FIG. 1 is a schematic of a system that enables a customer to communicate with a merchandiser over a computer network to return an item purchased from the merchandiser, in accordance with an embodiment of the present invention;

FIG. 2 is a schematic of a customer communication interface, in accordance with an embodiment of the present invention;

FIG. 3 is a flowchart diagram of a method for electronically communicating with a merchant to return an item, in accordance with an embodiment of the present invention; and

FIG. 4 is a flowchart diagram of a method for creating a return label, in accordance with an embodiment of the present invention.

### DESCRIPTION

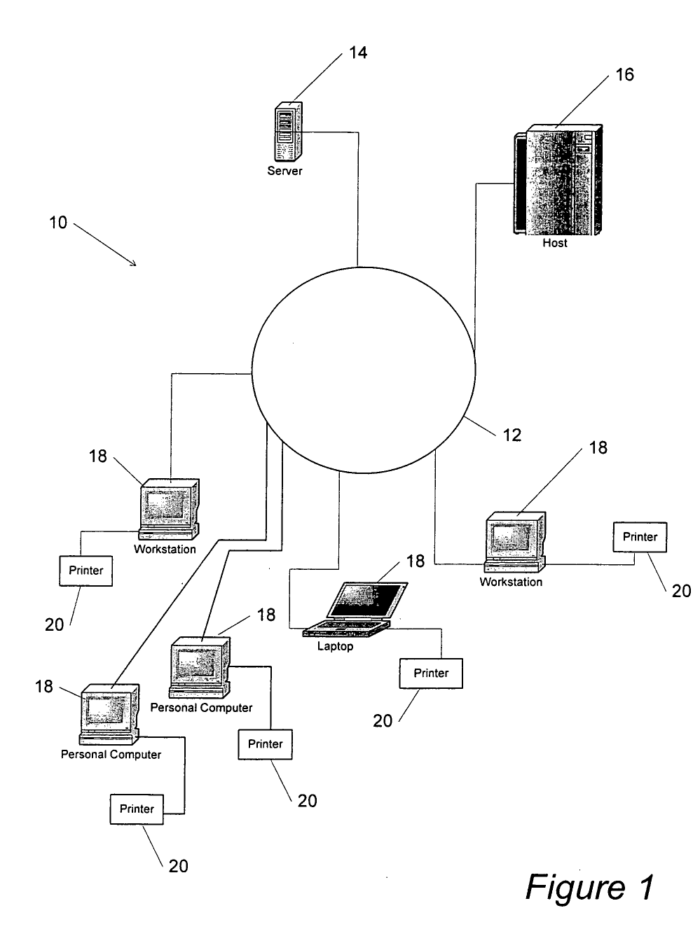

FIG. 1 illustrates one embodiment of a system 10 that enables a customer to communicate with a merchant over a computer network 12 to return an item purchased from the merchant. System 10 includes computer network 12, merchant computer 14, host or product computer 16 and customer computers 18. Computer network 12 may be any computer network such as the Internet, an intranet, or a public phone network. Further, network 12 may be a wired or a wireless network having a network of computers connected through satellite or radio transmissions, such as a Bluetooth network and/or a hard wired networks and/or a combination thereof.

Merchant computer 14 represents a computer or computer cluster typically having one or more server computers that store program code representing a customer communication interface. The customer communication interface could be a web page or a form or the like that is sent by the merchant and resides on customer computer 18. Alternatively, a merchant may use the facilities of host or product computer 16. Host computer 16 being coupled with computer network 12 may store computer code necessary to provide the customer interface or Internet web page. Additionally, host computer 16 has computer memory to store other programs and databases required to implement the merchant interface.

Herein, the phrase “coupled with” is defined to mean directly connected to or indirectly connected with through one or more intermediate components. Such intermediate components may include both hardware and software based components. Generally, merchant computer 14 and host computer 16 being coupled with each other through computer network 12 and may pass information back and forth for updating the customer communication interface as well as for other purposes. Customer computer 18 is typically any style of personal computer such as IBM or IBM compatible computers, those offered for sale by Apple Computer, Inc, personal digital assistants, cell phones, or other devices capable of accessing the merchant computer 14 via the computer network 12 as described herein.

Herein, customer may be an individual or business entity and a computer may be a single computer or a network of computers residing at an individual's residence or at a place of business. Thus, the present invention contemplates that system 10 conducts business-to-business as well as business-to-consumer transactions.

Further, computer 18 includes executable code for communicating with remote computers over a computer network such as the Internet 12. Such computer code may be, for example, an Internet browser that executes html/xml code and is configured to receive an Internet address, such as a Uniform Resource Locator (“URL”), for connecting to either merchant computer 14 or host computer 16 or both. Once connected to the merchant or host computer, the merchant's customer interface is viewable though the customer's Internet browser. Additionally, customer computer 18 may be coupled with a printer 20 for printing hard copies of information and the like generated on customer computer 18.

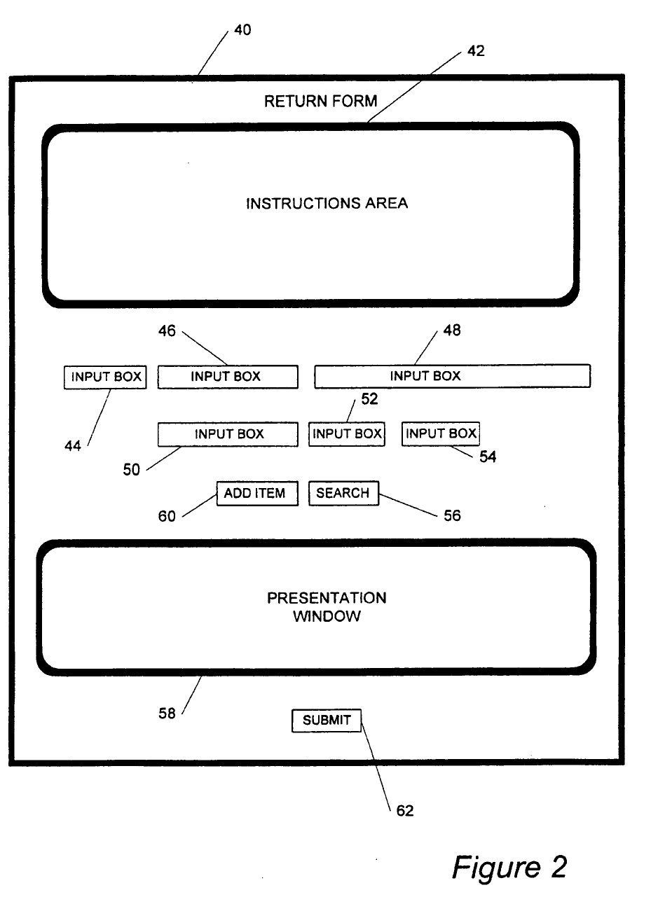

Referring now to FIG. 2, a schematic of a customer communication interface 40 is illustrated, in accordance with an embodiment of the present invention. According to the illustrated embodiment, customer interface 40 includes an instructions area 42 containing text and/or graphics instructing a customer on how to undertake the process of returning previously purchased items to the merchant. Further, customer communication interface 40 may include graphic user interface elements, such as a plurality of input boxes 44, 46, 48, 50, 52 and 54, for receiving information regarding the item to be returned and collectively represents a merchandise return form. For example, input box 44 may be the quantity of the particular item to be returned, input box 46 may be configured to receive an item identification number and input box 48 may be configured to receive a statement by the customer as to why they are seeking to return the item.

In one embodiment of the present invention, any one of these input boxes 44, 46, 48, 50, 52 and 54 may be associated with a list of acceptable inputs that the customer may select from (i.e. in the form of drop-down menus). Further, input boxes 50, 52 and 54 are directed to receiving an input from a customer identifying the invoice, by invoice number, on which the item to be returned appears. If the customer does not know the invoice number then the customer may search a merchant database using a conventional database search engine residing on merchant computer 14 or host computer 16 for the invoice number. The merchant database contains, for example, customer and product purchased information (i.e. name, address, purchased product identifiers, quantity of product purchased, date purchased, returned products, etc.). Input box 52 and 54 are utilized for this purpose. More specifically, if the customer selects input box 52, then the system will search the merchant database for the invoice number using a customer identifier, such as the name or identification number of the entity that ordered the items. However, if the customer selects input box 54 then the system will search the merchant database for the invoice numbers by the shipped to address indicated on the invoice. In order to activate the search, the customer selects input box 56. After the customer has selected the item from the results of the search presented in presentation window 58, the customer may select to add an item to the return list (also presented in window 58) from the list of search results by selecting the add item box 60. When the customer has finished inputting information concerning all of the items to be returned a submit form box 62 may be selected to forward an electronic return form to the merchant computer.

In an alternative embodiment of the present invention, access to the search engine and merchant database may require a password or other authentication. For example, merchant computer 14 or host 16 may be required to verify the identity of customer computer 18 through the use of cookies resident on customer computer 18. Thus, in this manner secure access to the merchant database is assured.

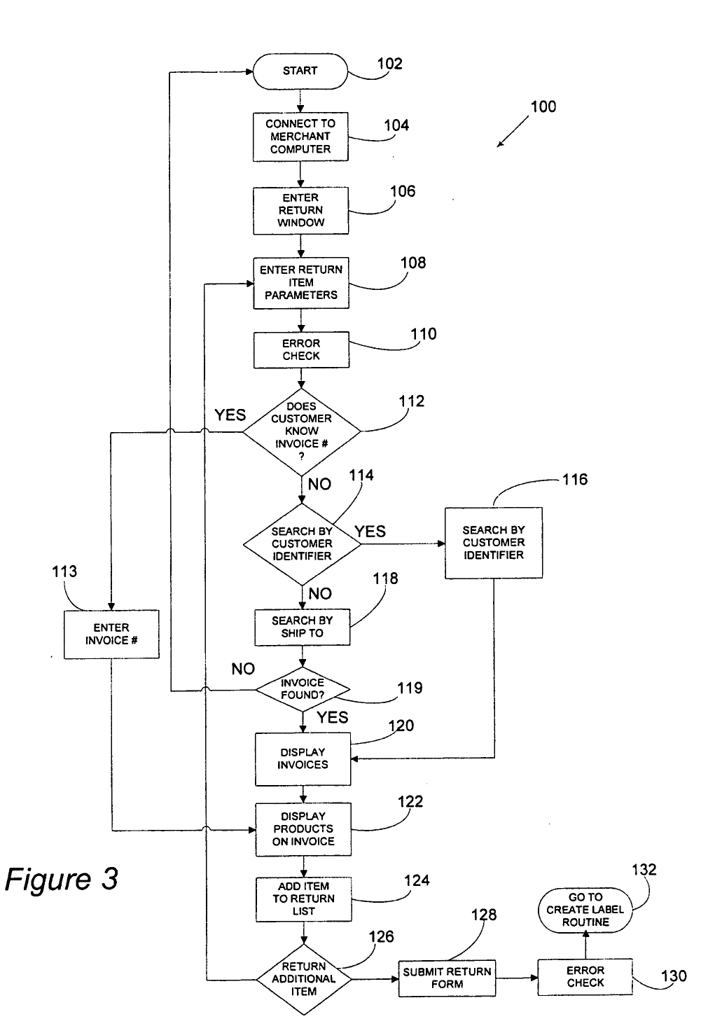

Referring now to FIG. 3, a method 100 for electronically communicating with a merchant to return an item is illustrated, in accordance with an embodiment of the present invention. Method 100 is initiated at block 102. A customer logs onto the merchant computer by, for example, entering the merchant's website by typing in the merchant's URL into a web browser, or to the merchant's designated host computer 16, as represented by block 104. At block 106, the customer selects a hyperlink or other means to enter a product return window, form or page (i.e. customer communication interface 40) from the merchant's website. Once the customer enters the returned product window of the merchant's website, the customer is requested to enter the various parameters particular to the item to be returned, as represented by block 108 and as described above. An error check may be performed, at block 110, to determine whether the item entered is eligible to be returned. For example, an item may not be eligible to be returned if it is an item that has been specifically indicated by the Merchant as non-returnable or if it has been previously returned. The error check may be undertaken by searching the merchant database or other databases containing items purchased and items returned and the associated invoice numbers, product identifiers, and customer identifiers. If it is determined that an item is not eligible to be returned a message to that effect is displayed to the customer. Thus, the system and method of the present invention provides the user with an early indication that the product is not eligible to be returned.

At block 112, the customer is asked whether they know the invoice number for the item to be returned. If the customer indicates that they do know the invoice number that the item appears on, then, at block 113, the customer is asked to enter the invoice number. The item is displayed along with the other items on the invoice, as represented by block 122. In an alternative embodiment, the item is added automatically or directly to the return list, at block 124, without being displayed. Alternatively, a customer may directly enter the invoice number (block 112 is skipped) to display the products listed on the invoice, as represented by blocks 113 and 122.

However, if the customer indicates that they do not know the invoice number on which the returned item appears then, at block 114, the customer is asked whether they want to search the merchant database by a customer identifier, such as the name or identification number of the entity who placed the order, as represented by block 114. If the customer indicates that they do want to search the merchant database by a customer identifier, then at block 116 the system executes a search routine that searches the merchant database by a customer identifier. At block 120, an order history is presented to the customer listing the orders, by invoice number, which have been requested by a customer having the associated customer identifier. At block 122, the customer may choose to view the items listed on each invoice. The customer then decides whether to add the invoice containing the returned item to the list of items to be returned, as represented by block 124.

Alternatively, the customer enters the return window and is given the option to either input an invoice number on which the item to be returned appears or input a product identifier for the product to be returned. The products are then displayed and the item to be returned is added to the product return list. The customer can then either enter a new invoice number, or select additional items for return from the list already displayed. Alternatively, the customer can select multiple items from the displayed list. The system performs an error check and then proceeds to block 132.

If however at block 114, the customer has not selected to search by customer identifier, then the system enters a search routine to search by the ship to address, as represented by block 118. The ship to address is the commercial or residential address to which the items or goods were sent. At block 120, an order history is presented to the customer listing the orders, by invoice number, which have been requested and shipped to the indicated ship to address. At block 122, the customer may choose to view the items listed on each invoice. The customer then decides whether to add the invoice containing the returned item to the list of items to be returned, as represented by block 124. If the system is unable to find and display the invoice then the customer is returned to start block 102 to initiate the process over again, as represented by block 119.

At block 126, the customer is asked whether they would like to return another item. If the customer would like to return another item, the system returns to block 108 where the customer is asked to enter the product or item parameters. If however the customer does not want to return another item, the customer may indicate that they are finished with the return item list and submit the list of returned items to the merchant, as represented by block 128. At block 130, an error check is performed to determine whether all the items listed on the return form are eligible to be returned. For example, an item may not be eligible to be returned if it is an item that has been specifically indicated by the Merchant as non-returnable or if it has been previously returned. The error check may be undertaken by searching a database containing items purchased and items returned and the associated invoice numbers, product identifiers, and customer identifiers. The customer is then directed to create a return label, as represented by block 132, and described below.

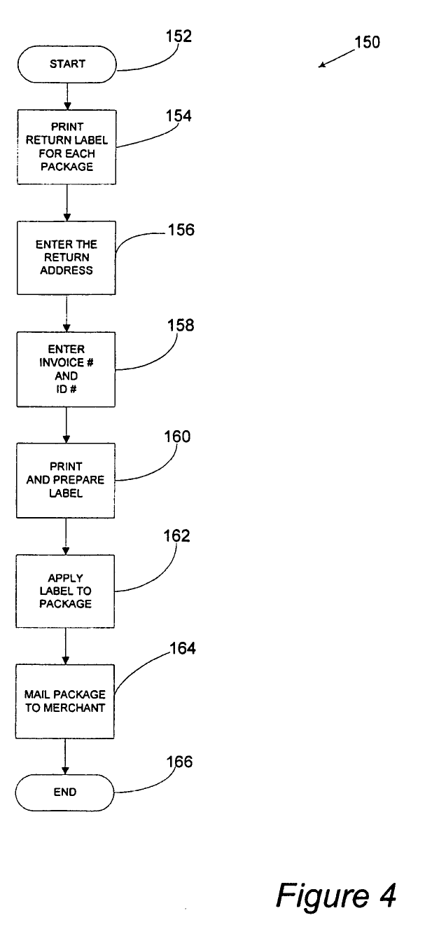

Referring now to FIG. 4 a method 150 for creating a return label is illustrated, in accordance with the illustrated embodiment. Method 150 is initiated at block 152 after error check 130. At block 154, the customer is instructed to print a return label for each package being returned to the merchant using the following process. At block 156, the customer is asked to enter the return name and address information from which the item is being shipped. At block 158, the customer is asked to add the invoice and customer identifier to the return label. The customer, at block 160, is requested to print and prepare (i.e. cut out) the return label for application to the package to be returned. At block 162, the customer is instructed to apply or adhere the label to the package to be returned. The package now being identified with the return label is brought to a post office for mailing to the merchant, as represented by block 164. In yet another embodiment of the present invention, no postage is necessary as the return label indicates that the postage is prepaid by the merchant. The method is concluded at block 166, however, would be repeated if additional return labels are required.

In yet another embodiment of the present invention, the process described above is preformed over a computer network, i.e. the internet. The customers access a return label form on the merchant or host computers and adds the instructed information to the form. The form can be downloaded to the customers computer after a prescribed event, i.e. completion of the return address. The form can be uploaded to the merchant computer after a prescribed event, i.e. completion of the invoice and customer identifiers. Further, an error check may be preformed on the return label by the merchant or host computers to verify the information added by the customer.

In still another embodiment of the present invention the system could pre-populate the fields of the return label with information already in the merchant database, such as the customer name and address. The customer could then have the option of editing this information prior to printing the return label.

The foregoing discussion discloses and describes a various embodiments of the invention. One skilled in the art will readily recognize from such discussion, and from the accompanying drawings and claims, that changes and modifications can be made to the invention without departing from the true spirit and fair scope of the invention as defined in the following claims.

1. A system for returning merchandise to a merchant, the system comprising:
a merchant computer in communication with a customer computer over a computer network, wherein the merchant computer includes a processor coupled to a memory area;
a first control logic stored in the memory area and executable by the processor of the merchant computer for receiving a merchandise identifier from a customer for identifying the merchandise to be returned;
a second control logic stored in the memory area and executable by the processor of the merchant computer for determining whether the merchandise is eligible to be returned by searching a memory area of the merchant computer using the merchandise identifier;
a third control logic stored in the memory area and executable by the processor of the merchant computer for creating a merchandise return form having the merchandise identifier of the merchandise that is eligible to be returned, based on said determining, said merchandise return form being capable of being edited by the customer;
a fourth control logic stored in the memory area and executable by the processor of the merchant computer for transmitting the merchandise return form from the merchant computer to the customer over the computer network for displaying on the customer computer; and
a fifth control logic stored in the memory area and executable by the processor of the merchant computer for receiving the edited merchandise return form at the merchant computer over the computer network from the customer computer.

2. The system of claim 1 further comprising a sixth control logic stored in the memory area and executable by the processor of the merchant computer for receiving an invoice identifier associated with an invoice having the merchandise identifier of merchandise to be returned.

3. The system of claim 2 wherein the sixth control logic further comprises providing the customer with a search engine to search for the invoice identifier.

4. The system of claim 2 further comprising a seventh control logic stored in the memory area and executable by the processor of the merchant computer for transmitting the invoice having the merchandise identifier to the customer computer for display.

5. The system of claim 1 further comprising a sixth control logic stored in the memory area and executable by the processor of the merchant computer for prompting a customer to enter a reason for returning the merchandise into the customer computer.

6. The system of claim 1 wherein the first control logic further comprises receiving a quantity of merchandise having that merchandise identifier to be returned.

7. The system of claim 6 wherein the first control logic further comprises receiving a merchandise SKU number.

8. The system of claim 1 further comprising a sixth control logic stored in the memory area and executable by the processor of the merchant computer for receiving a reason for returning the unwanted merchandise from the customer.

9. The system of claim 8 wherein the sixth control logic further comprises providing the customer with an option to select from a predefined list or reasons.

10. The system of claim 1 wherein the second control logic further comprises searching a database of returned merchandise to determine whether unwanted merchandise was previously returned.

11. The system of claim 1 wherein the fourth control logic includes displaying a quantity of the merchandise, a merchandise identifier, a description of the merchandise, a reason for returning the merchandise, and an invoice identifier having the merchandise identifier of the merchandise.

12. The system of claim 1 further comprising an sixth control logic stored in the memory area and executable by the processor of the merchant computer for displaying an merchandise return label identifying the merchandise, wherein the merchandise return label is capable of being printed and sent with the merchandise to the merchant.

13. A system for returning unwanted merchandise to a merchant over a computer network, the system comprising:
a merchant computer coupled with a customer computer through the computer network, the customer computer providing a merchandise identifier associated with the unwanted merchandise to the merchant computer, wherein the merchant computer has a memory area that is searchable for determining whether the merchandise corresponding to the received merchandise identifier is eligible to be returned; and
an executable program code stored in the memory area of the merchant computer for creating an unwanted merchandise return form to display on the customer computer having the merchandise identifier of the merchandise that is eligible to be returned, for receiving an input to the unwanted merchandise return form, displayed on the customer computer, from the customer to indicate that the customer has finished completing the unwanted merchandise return form, and for receiving the completed unwanted merchandise return form at the merchant computer over the computer network from the customer computer.

14. The system of claim 13 wherein the executable program code further comprises program code for prompting a customer to enter a reason for returning the merchandise into the customer computer.

15. The system of claim 13 wherein the executable program code further comprises program code for prompting a customer to enter the quantity of merchandise having that merchandise identifier to be returned.

16. The system of claim 15 wherein the executable program code further comprises program code for prompting a customer to enter a merchandise SKU number.

17. The system of claim 13 wherein the executable program code further comprises program code for prompting a customer to enter a reason for returning the merchandise.

18. The system of claim 17 wherein the executable program code further comprises program code for providing the customer with the option to select from a predefined list of reasons for returning the merchandise.

19. The system of claim 13 wherein the executable program code further comprises program code for providing the customer with a search engine to search for the invoice number.

20. The system of claim 13 wherein the executable program code further comprises program code for searching a database of returned merchandise to determine whether merchandise was previously returned.

21. The system of claim 13 wherein the executable program code further comprises program code for displaying the unwanted merchandise return form having a quantity of the unwanted merchandise, the merchandise identifier associated with the unwanted merchandise, a reason for returning the unwanted merchandise, and the invoice number of an invoice having the unwanted merchandise printed thereon.

22. The system of claim 13 further comprising a printer for printing an unwanted merchandise return label, wherein the unwanted return label is sent with the unwanted merchandise to the merchant.

23. A system for returning unwanted merchandise to a merchant over a computer network, the system comprising:
a merchant computer coupled with a customer computer through the computer network, the customer computer providing a merchandise identifier associated with the unwanted merchandise to the merchant computer, wherein the merchant computer has a memory area that is searchable for determining whether the merchandise corresponding to the received merchandise identifier is eligible to be returned; and
a means for creating an unwanted merchandise return form to display on the customer computer, wherein the form has the merchandise identifier of the merchandise that is eligible to be returned, for receiving an input to the unwanted merchandise return form, displayed on the customer computer, from the customer to indicate that the customer has finished completing the unwanted merchandise return form, and for receiving the completed unwanted merchandise return form at the merchant computer over the computer network from the customer computer.

24. The system of claim 23 wherein the means for creating an unwanted merchandise return form is executable program code residing in the memory area of the merchant computer.

25. The system of claim 24 wherein the executable program code further comprises program code for prompting a customer to enter a reason for returning the merchandise into the customer computer.

26. The system of claim 24 wherein the executable program code further comprises program code for prompting a customer to enter the quantity of merchandise having that merchandise identifier to be returned.

27. The system of claim 26 wherein the executable program code further comprises program code for prompting a customer to enter a merchandise SKU number.

28. The system of claim 24 wherein the executable program code further comprises program code for prompting a customer to enter a reason for returning the merchandise.

29. The system of claim 28 wherein the executable program code further comprises program code for providing the customer with the option to select from a predefined list or reasons.

30. The system of claim 24 wherein the executable program code further comprises program code for providing the customer with a search engine to search for the invoice number.

31. The system of claim 24 wherein the executable program code further comprises program code for searching a database of returned merchandise to determine whether merchandise was previously returned.

32. The system of claim 24 wherein the executable program code further comprises program code for displaying the unwanted merchandise return form having a quantity of the unwanted merchandise, the merchandise identifier associated with the unwanted merchandise, a reason for returning the unwanted merchandise, and the invoice number of an invoice having the unwanted merchandise printed thereon.

33. The system of claim 24 further comprising a printer for printing an unwanted merchandise return label, wherein the unwanted return label is sent with the unwanted merchandise to the merchant.

34. A method for returning unwanted merchandise to a merchant having a merchant computer in communication with a customer computer over a computer network, the method comprising:
receiving a merchandise identifier from a customer for identifying the unwanted merchandise to be returned;
determining whether the unwanted merchandise is eligible to be returned by searching a memory area of the merchant computer using the merchandise identifier;
creating an unwanted merchandise return form having the merchandise identifier of the merchandise that is eligible to be returned, based on said determining, said unwanted merchandise return form being capable of receiving input from the customer;
transmitting the unwanted merchandise return form from the merchant computer to the customer over the computer network for displaying on the customer computer;
receiving an input to the unwanted merchandise return from the customer to indicate that the customer has finished completing the unwanted merchandise return form; and
receiving the completed unwanted merchandise return form at the merchant computer over the computer network from the customer computer.

35. The method of claim 34 further comprising receiving an invoice identifier associated with an invoice having the merchandise identifier of unwanted merchandise to be returned.

36. The method of claim 35 wherein receiving an invoice identifier further comprises providing the customer with a search engine to search for the invoice identifier.

37. The method of claim 35 further comprising transmitting the invoice having the merchandise identifier to the customer computer for display.

38. The method of claim 34 further comprising prompting a customer to enter a reason for returning the unwanted merchandise into the customer computer.

39. The method of claim 34 wherein receiving a merchandise identifier further comprises receiving a quantity of merchandise having that merchandise identifier to be returned.

40. The method of claim 39 wherein receiving a merchandise identifier further comprises receiving a merchandise SKU number.

41. The method of claim 34 further comprising receiving a reason for returning the unwanted merchandise from the customer.

42. The method of claim 41 wherein receiving a reason further comprises providing the customer with an option to select from a predefined list or reasons.

43. The method of claim 34 wherein determining whether the unwanted merchandise is eligible to be returned further comprises searching a database of returned merchandise to determine whether unwanted merchandise was previously returned.

44. The method of claim 34 wherein transmitting a unwanted merchandise return form includes displaying a quantity of the unwanted merchandise, a merchandise identifier, a description of the unwanted merchandise, a reason for returning the unwanted merchandise, and an invoice identifier having the merchandise identifier of the unwanted merchandise.

45. The method of claim 34 further comprising displaying an unwanted merchandise return label identifying the unwanted merchandise, wherein the unwanted merchandise return label is capable of being printed and sent with the unwanted merchandise to the merchant.
